(19) United States
(12) Patent Application Publication
(10) Pub. No.: US 2012/0239894 A1
(43) Pub. Date: Sep. 20, 2012

(54) BACKUP METHOD FOR PORTABLE DEVICE

(75) Inventors: Johnny CHEN, Santa Ana, CA (US); Ping-shun Zeung, Santa Ana, CA (US)

(73) Assignee: I O INTERCONNECT, LTD.

(21) Appl. No.: 13/487,236

(22) Filed: Jun. 3, 2012

Related U.S. Application Data
(63) Continuation-in-part of application No. 13/302,788, filed on Nov. 22, 2011.
(60) Provisional application No. 61/435,631, filed on Jan. 24, 2011.

(51) Int. Cl. G06F 12/16

(52) U.S. Cl. 711/162; 711/E12.103

(57) ABSTRACT

An embodiment of the invention provides a backup method for a portable device. The method includes steps of: creating a first log file according to a first file that has to be stored in a backup device; connecting the portable device to the backup device; transmitting the first log file to the backup device; reading the first log file, by the backup device, and storing the first file to a storage device of the backup device; wherein the first log file is transmitted to the storage device via a buffer that is controlled by a controller of the backup device.

### CROSS REFERENCE TO RELATED APPLICATIONS

This application is a Continuation-In-Part of application Ser. No. 13/302,788, filed Nov. 22, 2011, which claims the benefit of provisional Application No. 61/435,631, filed on Jan. 24, 2011, the entirety of which is/are incorporated by reference herein.

### BACKGROUND OF THE INVENTION

1. Field of the Invention

The present invention relates to a backup method, and in particular relates to a backup method for a portable device.

2. Description of the Related Art

With the growth of the usage of the portable device, a problem has been raised, the backing up of data of the portable device. One solution is to connect the portable device to a computer or data storage device and store data therein. However, this solution may require some driver or specific software for the computer to retrieve and backs up data of the portable device and it is not convenient for a user. If the computer does not install the corresponding application program or driver, the computer cannot access the portable device even to back up data of the portable device.

### BRIEF SUMMARY OF THE INVENTION

An embodiment of the invention provides a backup method for a portable device. The method comprises steps of: creating a first log file according to a first file that has to be stored in a backup device; connecting the portable device to the backup device; transmitting the first log file to the backup device; reading the first log file, by the backup device, and storing the first file to a storage device of the backup device; wherein the first log file is transmitted to the storage device via a buffer that is controlled by a controller of the backup device.

Another embodiment of the invention provides a dock for storing data of a portable device. The dock comprises a first storage device, a buffer coupled to the first storage device, and a controller. The controller detects whether the portable device connects to the dock, and when the portable device connects to the dock, a first log file is transmitted to the first storage device via the buffer. The controller then reads the first log file to store a first file from the portable device, and the controller creates a second log file indicating a backup status of the first file.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a backup mechanism for a portable device according to an embodiment of the invention.

FIG. 2 is a flowchart of a backup method according to an embodiment of the invention.

FIG. 3 is a schematic diagram of a backup mechanism for a portable device according to another embodiment of the invention.

FIG. 4a shows a backup setting menu according to an embodiment of the invention.

FIG. 4b shows a customized backup setting menu according to an embodiment of the invention.

FIG. 4c shows a re-store setting menu according to an embodiment of the invention.

FIG. 5 is a schematic diagram of a backup mechanism for a portable device according to another embodiment of the present invention.

FIG. 6 is a flowchart of a backup and re-store method according to another embodiment of the invention.

FIG. 7 is a schematic diagram of a backup mechanism for a portable device according to another embodiment of the invention.

FIG. 8 is a schematic diagram of a backup mechanism for a portable device according to another embodiment of the invention.

FIG. 9 a flowchart of a backup method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

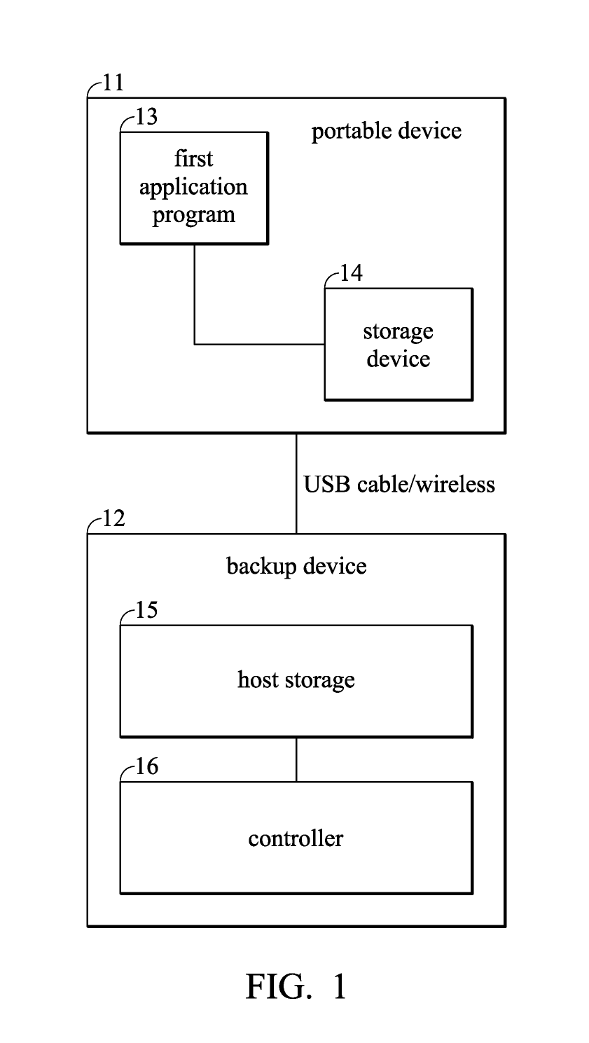

FIG. 1 is a schematic diagram of an embodiment of a backup mechanism for a portable device according to an embodiment of the present innovation. The portable device 11 comprises a first application program 13 and a storage device 14, such as an SD card, CF card or flash memory. The backup device 12 comprises a host storage 15 and a controller 16. When a user wants to backup files stored in the storage device 14, the user uses the first application program 13 to select and mark files to be backed up and the first application program 13 outputs a log file indicating which files have to be backed up. When the backup device 12 is electrically connected to the portable device 11, the backup device 12 reads the log file of the portable device 11 to know which files have to be backed up. The backup device 12 may directly read the log file stored in the storage device 14 and the log file would be reserved in the storage device 14. In another embodiment, the backup device 12 retrieves and stores the log file in the backup device, and the original log file stored in the will be deleted by the backup device 12. Then, the backup device 12 acquires and stores the files to be backed up in the host storage 15. When the backup device 12 is connected to the portable device 11, the control of the storage device 14 is transferred to the controller 16 of the backup device 12. After the backup device 12 finishes storing the file, the backup device 12 creates and stores a host log file in the storage device 14. The host log file records the file storage status. Finally, the backup device 12 is disconnected from the portable device 11, and the first application program 13 reads the host log file to know a backup result. The host log file may be temporality or permanently stored in the storage device 14. For example, the host log file may be deleted after the first application program 13 reads it for the security concern.

The present data backup procedure mainly comprises three parts. First, before the portable device 11 is connected to the backup device 12, the first application program 13 is executed to select and mark files to be backed up by a user. The first application program 13 then creates and stores a log file. The log file contains the information of the files to be backed up. The information may comprise file names of the file to be backed up.

Second, when the portable device 11 is connected to the backup device 12, the control of the storage device 14 is transferred to the backup device 12. In other word, the portable device 11 can operate as a peripheral device of the backup device 12. The backup device 12 reads the log file and stores the files to be backed up to the host storage 15. After storage, the backup device 12 creates and stores a host log file in the storage device 14, and breaks down the connection to the portable device 12.

Third, the first application program 13 is executed and reads the host log file to know the status of the backup.

In the present embodiment, the log file may not only record the information of the files to be backed up, but also a destination folder or path that indicates the destination folder.

In another embodiment, the log file contains a timestamp and the backup device 12 also stores the log file from the portable device 11. When the backup device 12 accesses the log file from the portable device 11, the backup device 12 also reads a previous log file stored in the backup device 12, and the backup device 12 only stores the unstored files according to the log file and the previous log file. The backup device 12 comprises a first log file database storing the log files from the portable device 12, and the portable device 11 comprises a second log file data storing the host log files created by the backup device 12. Each time the portable device 11 backs up the data or files to the backup device 12, the first application program 13 or the backup device 12 can find a previous host log file or a previous log file to determine which files are new for backup. The described backup mechanism also can be applied to the restore function.

The host log file also contains a timestamp, and when the first application program 13 creates the log file, the first application program 13 will check a previous host log file to see whether the current selected files have been stored in the backup device 12. If yes, the current log file will exclude the stored files from the current log file. It is noted that, if the destination folder of the destination path of the previously stored files is different from the current destination folder of the destination path, the stored files will be stored in the current destination folder of the destination path.

The described paragraphs are focused on the backup mechanism for the portable device 11. Another embodiment of the restored mechanism for the portable device 11 is discussed in the following. When a user wants to restore some files from the backup device 12 to the portable device 11, the first application program 13 creates a first log file indicating which files have to be restored to the portable device 11. When the backup device 12 is connected to the portable device 11, the controller 16 reads the first log file and restores the requested files to the portable device 11. After restoration, the backup device 12 also creates and stores a first host log file to the storage device 14.

Via the first application program 13, a user can set data between two dates to be restored from the backup device 12 to the portable device 11. For example, if a user wants to restore the pictures taken from Jan. 1, 2011 to Jan. 10, 2011, the user can input some parameters, such as date and data type information, via the first application program 13 and then the first application program searches matched files stored in the portable device and creates the log file according to the user's inputs. Furthermore, the user can set which type of files to be backed up via the first application program. Similarly, this can also be applied to the restore mechanism. In this embodiment, the type of the file means the file format, such as JPG, JPEG, RAM file format, audio file format, video file format or other formats.

In the present embodiment, the backup device 12 may also comprise a second application program for backing up the data of the portable device 11 or restoring the data from the backup device 12 to the portable device. The backup device 12 may also comprise a dock for connecting a connector of the portable device 11. Wireless connection mechanisms, security mechanisms or synchronization mechanisms may also be applied to the portable device 11 and backup device 12.

In the previous description, the embodiment is illustrated with wired or physical connection between the portable device 11 and the backup device. However, the invention is not limited thereto. The described backup mechanism can also be applied in the situation that the portable device wirelessly connects the backup device. The backup device 12 can communicate with the portable device 11 via wireless interface, such as Wifi, WiMax, Bluetooth, IrDa, NFC (Near Field Communication) or other wireless interfaces. When a distance between the portable device 11 and the backup device 12 is shorter than a predetermined distance, the backup device 12 automatically wirelessly connects to the portable device and the portable device 11 transfers the control of the storage device 14 to the backup device 12. Although the portable device 11 is connected to the backup device 12 actually, the backup device 12 only sees the storage device 14 in the aspect view of the backup device 12. Simply speaking, the backup device 12 is virtually connected to the storage device 14 but actually connected to the portable device. After the virtual connection between the storage device 14 and the backup device 12 is established, the control of the storage device 14 is transferred to the backup device 12. It means that the user of the portable device 11 cannot see the storage device 14. When the backup device 12 accesses the storage device 14, the command, request, or data to the storage device 14 is still transferred by a processor or a control unit of the portable device 11. The backup device 12 then reads the log file stored in the storage device 14 and backs up the files in the backup device 12. After backing up, the backup device breaks down the wireless connection to the portable device 11 and the control of the storage device 14 is returned to the portable device 11. Furthermore, when the storage device 14 is virtually connected to the backup device 12, a synchronization application program can be executed to directly synchronize and back up the data of the portable device 11 and via the wireless connection, the backup device 12 can simultaneously connects to more than one portable device or other computing device to back up the data therein when the wireless connection has been established.

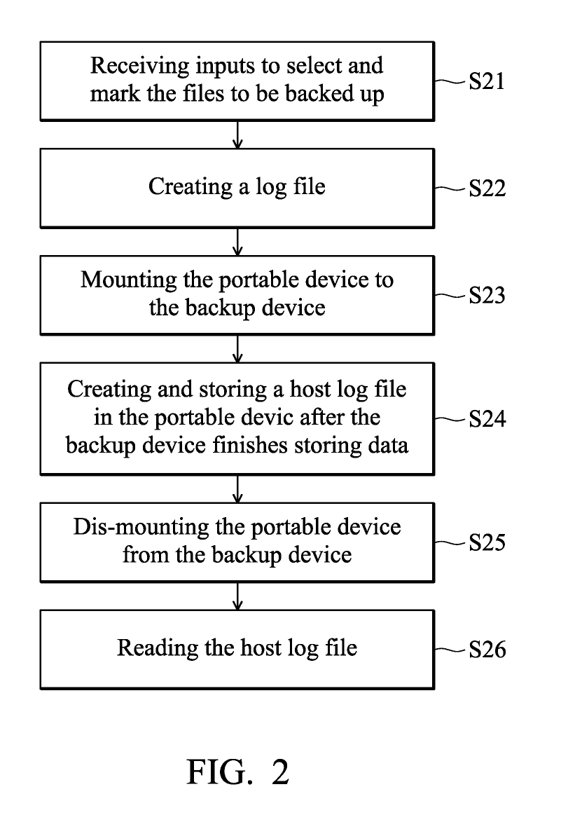

FIG. 2 is a flowchart of a backup method according to an embodiment of the present embodiment. In step S21, the portable device receives inputs to select and mark the files to be backed up. A user can input parameters via a touch panel or keypad of the portable device to select files to be backed up. Furthermore, voice control may also be applied. In step S22, a first application program of the portable device creates a log file according to user inputs. In step S23, the backup device mounts the portable device, and the control of the storage device 14 is then transferred to the backup device. The backup device reads the log file and stores the files from the portable device to the backup device according to the log file. In step S24, when the backup device finishes storing data, the backup device creates and stores a host log file in the portable device. In step S25, the backup device dis-mounts the portable device. In step S26, the portable device reads the host log file to check the status of the backed up file.

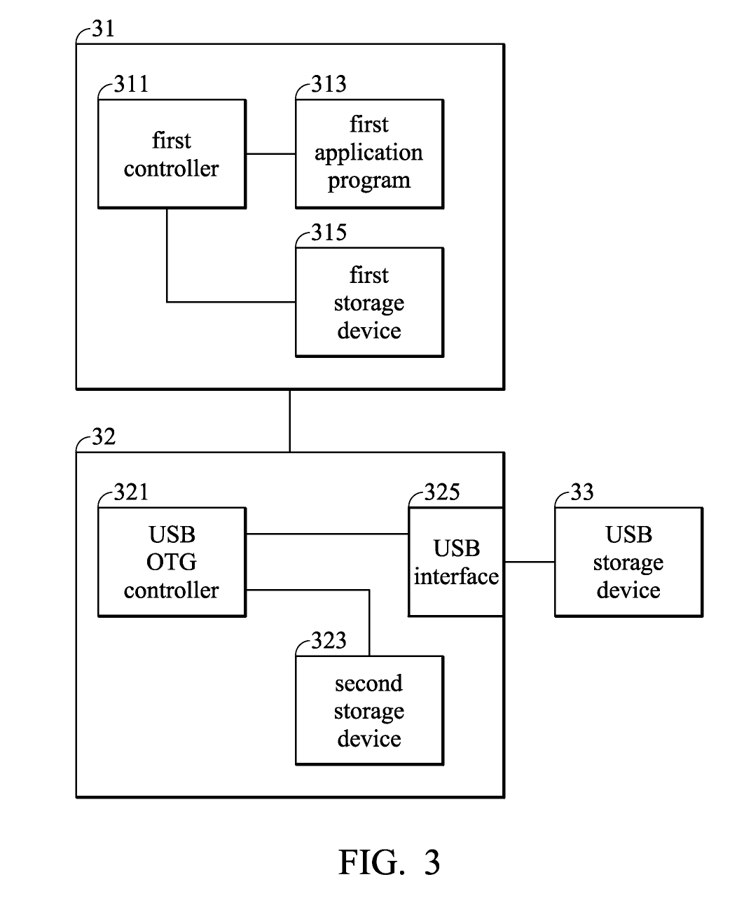

FIG. 3 is a schematic diagram of a backup mechanism for a portable device according to another embodiment of the invention. The portable device 31 comprises a first controller 311, a first application program 313 and a first storage device 315. The dock 32 comprises a USB OTG (On To Go) controller 321, a second storage device 323 and a USB connector for connecting a USB storage device 33. The portable device 31 has a connector for connecting the dock 32. In another embodiment, the dock 32 has a first slot with a male connector and the portable device 31 has a female connector for connecting the male connector. In another embodiment, the portable device 31 connects to the dock 32 via a connection cable. The first storage device 315 may be a SD card or other kinds of memory cards. The first storage device 312 is inserted and mounted to the portable device 31 by user and stores user's personal data. The portable device 31 may comprises another storage device storing the necessary data for the operation of the portable device 31, such as the operating system, application programs or hardware configuration data.

When the portable device 31 connects to the dock 32, the control of the first storage device is transferred to the USB OTG controller 321. In other words, the first storage device 315 can only be accessed by the USB OTG controller 321 and cannot be accessed by the first controller 311. The first application program 313 is executed by the first controller 311 and user can select at least one file to be backed up to the dock 32 via the first application program 313. After selecting files, the first application program 313 creates a first log files. The first application program 313 may show a setting menu for user to select files to be backed up.

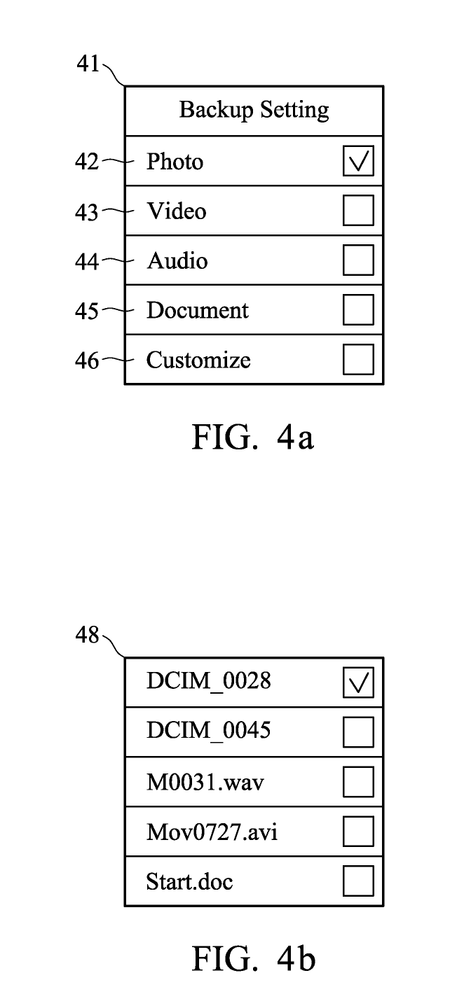

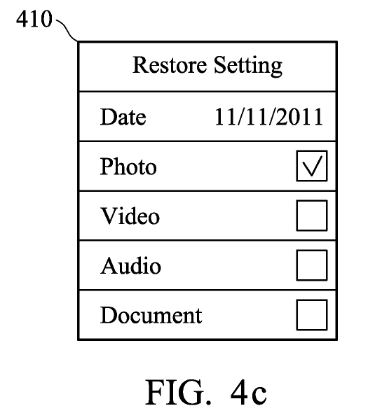

Please refer to FIG. 4a. FIG. 4a shows a backup setting menu according to an embodiment of the invention. The backup setting menu 41 comprises option fields 42 to 46. When the option field 42 is selected, all the photo file or image file of the portable device 31 would be backed up to the dock 32. When the option field 43 is selected, all the video files of the portable device 31 would be backed up to the dock 32. When the option field 44 is selected, all the audio files of the portable device 31 would be backed up to the dock 32. When the option field 45 is selected, all the document files of the portable device 31 would be backed up to the dock 32. When the option field 46 is selected, another option menu 48 pops out. The option menu 48 contains file names of all files of the portable device 31 and the user can select files to be backed up via the option menu 48. After selecting, the first application program 313 creates a log file for the dock 32 to back up files. The backup setting menu further comprises an option field (not shown in FIG. 4a) to back up the contact list of the portable device. The contact list does not limit to the phone contact list, and the contact list related to a social network service can also be backed up to the backup device.

In another embodiment, the backup setting menu 41 comprises a destination folder setting option and a synchronization option. The user can set a specific folder for storing the backup data from the portable device 31 via the destination folder setting option and creates another folder for synchronizing a designated folder of the portable device 31. If the user has set synchronization option, the dock 32 will automatically synchronize the portable device 31 and store the modified, changed or newly added file in the designated folder when the portable device 31 connects to the dock 32.

It is noted that the first application program 313 can be executed at anytime base on the need of the user. The user can first executes the first application program 313 to create the first log file and then connects the portable device 31 to the dock 32. In another example, the user can directly connect the portable device 31 to the dock 32 and after the first controller 311 detects that the portable device 31 has been connected to the dock 32, the first application program 313 is then automatically executed.

The first log file contains the information of the files to be backed up. The information may comprise file names of the files to be backed up. The log file may not only record the information of the files to be backed up, but also a destination folder or path indicating the destination folder that the files to be backed up. In another embodiment, the log file contains a timestamp and the USB OTG controller 321 backs up data of the portable device 31 only according to the file creation date. For example, the dock 32 has backed up the data of the portable device 31 on Jan. 1, 2011, and when the user connects the portable device 31 to the dock 32 on Jan. 11, 2011, the dock 32 only backs up the data generated, changed or modified between Jan. 1, 2011 and Jan. 11, 2011 in the portable device 31. In other words, an incremental backup mechanism is applied in the dock 32.

The incremental backup preserves data by not creating multiple copies that are based on the differences in those data: a successive copy of the data contains only that portion which has changed since the preceding copy has been created. The most basic form of incremental backup involves only those files that have changed since the last backup. Since changes are typically low, incremental backups are much smaller and quicker than full backups.

After the portable device 31 connects to the dock 32, the USB OTG controller 321 reads the first log file stored in the first storage device 315 and then backs up files from the first storage device 315 to the second storage device 323 or the USB storage device 33. The USB OTG controller 321 can store the backup data in different folders according to different data sources. For example, the dock 32 creates a first folder to store the backup data from a first portable device and creates a second folder to store the backup data from a second portable device. When the portable device 31 connects to the dock 32, the USB OTG controller 32 first identifies the portable device 31 to select or create a corresponding folder to store the backup data. The dock 32 comprises a USB connector 325 for connecting the USB storage device 33. The dock 32 can store the backup data to the second storage device 323 or the USB storage device 33 according to first log file. In another embodiment, when the second storage device 323 is full or does not exist, the dock 32 stores the backup data to the USB storage device 33.

After the dock 32 stores the backup data, the USB OTG controller 321 creates and stores a second log file to the first storage device 315. Then, the USB OTC controller 321 transfers the control of the first storage device 315 back to the first controller 311. This means that the first storage device 315 can be accessed by only the first controller 311. The first controller 311 reads the second log file to know the backup status, such as backup fail, backup success or the backup date.

In this embodiment, the dock 32 can restore the backup data to the portable device 31. The user first executes the first application 313 to select a restore date or the files to be restored, and then creates a third log file. For example, if a user wants to restore the pictures taken from Jan. 1, 2011 to Jan. 10, 2011, the user sets some parameters, such as the date and the data format information, via the first application program 43 to create the third log file. When the portable device connects to the dock 32, the USB OTG controller 321 reads the third log file and stores the selected files to the first storage device 315. In another embodiment, the user can restore files with a specific format. For example, when the user wants to restore the pictures from the dock 32 to the portable device 31, the user can create a restore log file via the first application program 313. The first application program 313 can show a setting menu, such as shown in FIG. 4c, for user. The user first sets a restore date and then selects the data type of the restored data.

Although the described paragraphs illustrate the backup or restore mechanism with four data types, the user still can select specific format to be backed up or restored via the first application program 313. For example, the formats of photo comprise JPG format, JPEG format, BMP format and other formats, and the user can select only the photo with JPG format to be backed up or restored. All the setting of backup and restore will be transformed to data that can be read by the USB OTG controller 321 and stored in the log file.

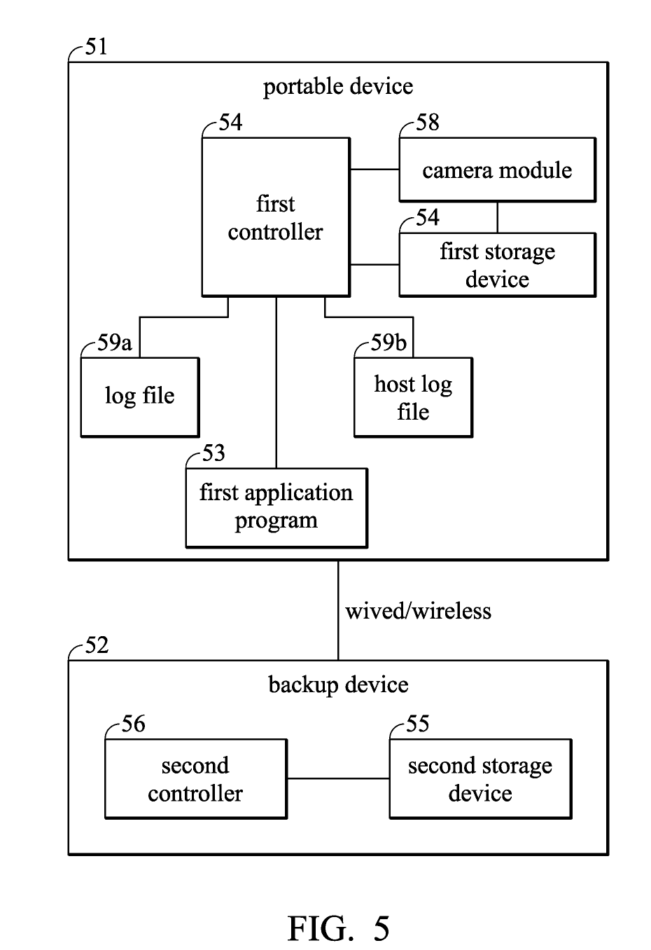

FIG. 5 is a schematic diagram of a backup mechanism for a portable device according to another embodiment of the present invention. The portable device 51 comprises a first controller 57, a camera module 58, a first application program 53 and a first storage device 54, such as an SD card, CF card or flash memory. In another embodiment, the first storage device 54 is external and inserted in the portable device 51.

The backup device 52 comprises a second storage device 55 and a controller 56. When a user wants to backup and store files to the second storage device 55, the user first uses the first application program 53 to select first files that have to be backed up and then the first application program 53 creates a log file 59a according to the first files. The log file 59a comprises the file names of the first files, formats of first files and a timestamp recording the backup date of the first files.

The following paragraphs are focused on the backup mechanism for the portable device 51 that has the same operating system as the backup device. When the backup device 52 is electrically connected to the portable device 51, the control of the first storage device 54 is first transferred to the second controller 56, and then the second controller 46 reads the log file 59a of the portable device 51 to know which files have to be backed up. The backup device 52 acquires and stores the first files to the second storage device 55 according to the log file 59a. After the first files are stored in the second storage device 55, the second controller creates and stores a host log file 59b in the portable device 51. The host log file 59a records the status of the backup procedure of the first files. Finally, the backup device 52 is disconnected from the portable device 51, and the first controller 57 reads the host log file to know the backup status.

In FIG. 5, the portable device 51 comprises a camera module 58 for taking photos. The photos taken by the camera module 58 also contain a timestamp. Therefore, the backup device 52 can automatically back up the photos according to the timestamp. For example, when the portable device 51 connects to the backup device 52 for a first time, a second application program (not shown in FIG. 5) automatically stores all the photos and pictures of the portable device 51. Then, the second application program finds and records a latest date from the timestamps of the corresponding photos and pictures. When the portable device 51 connects to the backup device 52 again, the second application program finds photos or pictures that are not stored in the backup device 52 according to the latest date, and then stored the unstored photos or pictures in the second storage device 55.

A restored mechanism for the portable device 51 is also discussed in the following. When a user wants to restore second files from the backup device 52 to the portable device 51, the first application program 53 first creates a first log file containing the information of the second files that have to be restored to the portable device 51. When the backup device 52 is connected to the portable device 51, the second controller 56 reads the log file and restores the second files to the portable device 51. After restoration, the backup device 52 also creates and stores a host log file to the portable device 51.

Via the first application program 57, a user can only select data between two dates to be restored from the backup device 52 to the portable device 51. For example, if a user wants to restore the pictures taken from Jan. 1, 2011 to Jan. 10, 2011, the user can input some parameters, such as the date and the data format information, via the first application program 53 and then the first application program 53 creates the log file according to the user's choices. Furthermore, a user can select to backup files with some specific format to be backed up device 52 via the first application program 53.

In the present embodiment, the backup device 52 may also comprises the second application program for backing up the data of the portable device 51 or restoring the data from the backup device 52 to the portable device 51. The backup device 52 may also comprises a dock for connecting a connector of the portable device. Wireless connection mechanisms, security mechanisms or synchronization mechanisms may also be applied to the portable device 51 and backup device 52.

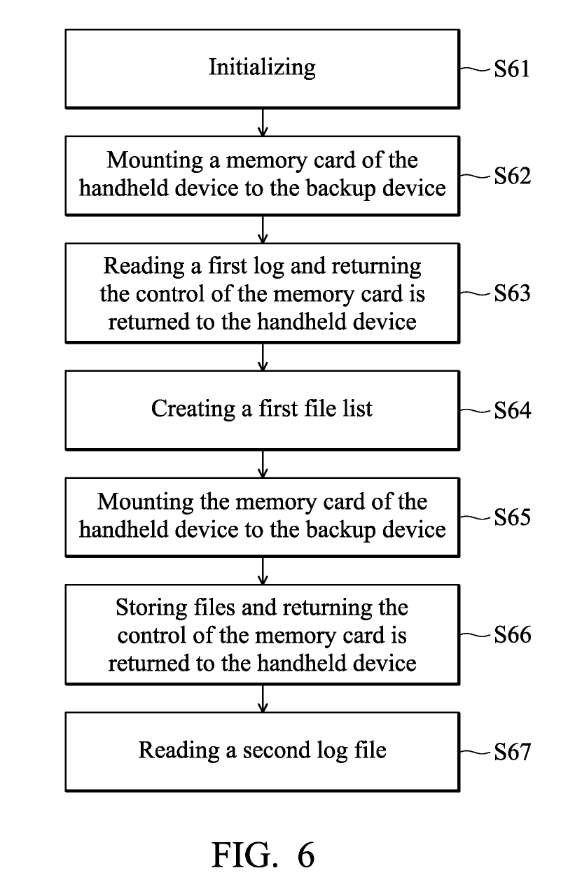

FIG. 6 is a flowchart of a backup and re-store method according to another embodiment of the invention. In step S61, an application program or a backup device is initialized. The backup device connects to a handheld device to back up data from the handheld device to the backup device or re-store data from the backup device to the handheld device. The initialization comprises a step of scanning the handheld device and the backup device to find storage type devices comprising both internal and external storage medium. Before or during the initialization, user can select which data to be backed up or determines a recovery date to restore data via an input menu or interface. Then, the handheld device creates and stores a first log file in a memory card or an external storage device of the handheld device. In the step S62, the memory card of the handheld device is mounted to the backup device. It means that the control of the memory card is transferred from the handheld device to the backup device. In other words, the user of the handheld device cannot access the memory card via the handheld device.

In the step S63, the backup device reads the first log file, wherein the first log file contains the information of the files to be backed up or restored. In another embodiment, the backup device duplicates the first log file and stored the duplicated first log file to a storage device of the backup device. After that, the control of the memory card is returned to the handheld device. In step S64, the backup device compares the current files with the files to be backed up or restored to create a first file list showing only the files to be deleted or created. In the step S65, the memory card the handheld device is mounted to the backup device again. In the step S66, the backup device stores files or deletes files according to the file list. After that, the backup device returns the control of the memory card to the handheld device. In step S67, the handheld device reads a second log file generated in the step S66 to know the backup or re-store status.

The first log file or the second log file comprises at least three parts: status list, command list and file list. The status list indicates result of the backup operation or the re-store operation. The command list is generated only by the handheld device to inform the backup device which operation is adopted. The file list is the key feature of the log file. The file list comprises file names of files to be backed up or deleted, directory of the files and a directory structure of the memory card. When generating the first log file, a backup program of the handheld device may directly records the current directory structure of the memory card or only the directory structure of the files related to the backup operation or re-store operation. The backup device then compares the directory structure of the first log file with a current directory of the backup device to generate the first file list. In another embodiment, the backup device compares the first log file with a previous log file that the handheld device generated to generate the firs log file.

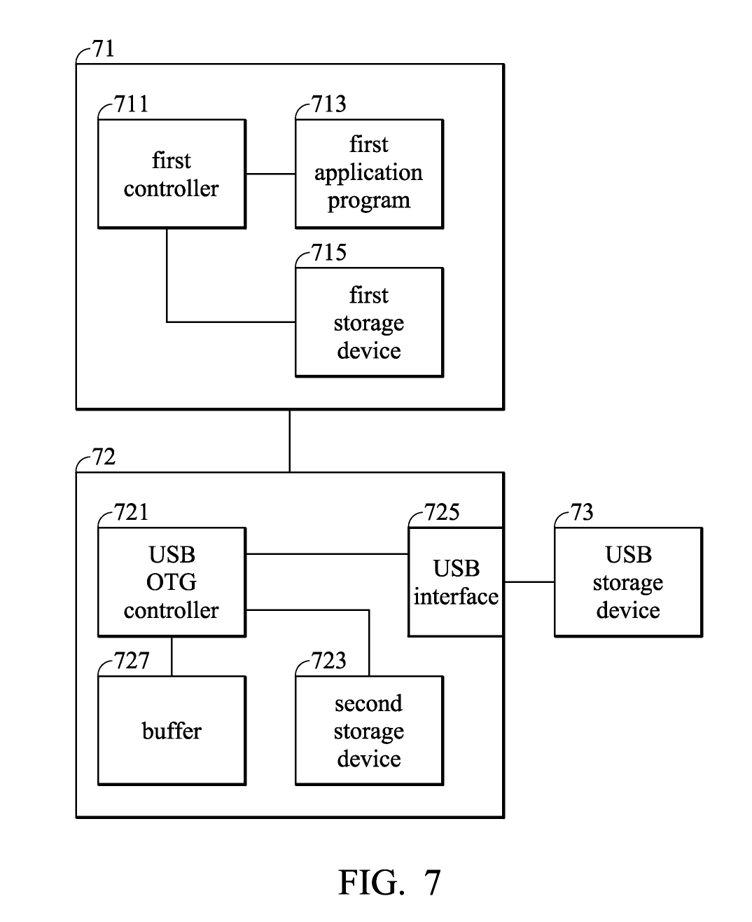

FIG. 7 is a schematic diagram of a backup mechanism for a portable device according to another embodiment of the invention. The portable device 71 comprises a first controller 711, a first application program 713 and a first storage device 715. The dock 72 comprises a USB OTG (On To Go) controller 721, a buffer 727, a second storage device 723 and a USB connector 725 for connecting a USB storage device 73. In this embodiment, the buffer 727 may be a memory device that is only controlled by the USB OTG controller 721. In this embodiment, the buffer 727 may be a random access memory (RAM). In other embodiment, the buffer 727 may be embedded with the USB OTG controller 721.

The portable device 71 has a connector for connecting the dock 72. In another embodiment, the dock 72 has a first slot with a male connector and the portable device 71 has a female connector for connecting the male connector. In another embodiment, the portable device 71 connects to the dock 72 via a connection cable.

When the portable device 71 connects to the dock 72, an authentication procedure may be applied to the portable device 71 by the USB OTG controller 721. When the portable device 71 is authenticated or confirmed by the USB OTG controller 721, the control of the buffer 727 is transferred to the first controller 711. In this case, the dock 72 is controlled by the portable device 71.

In one embodiment, when the portable device 71 wants to stores files or data to the dock 72, the first controller 711 first transmits the files or data to the buffer 727 and then, the USB OTG controller 721 transmits and stores data or files stored in the buffer 727 to the second storage device 723 or the USB storage device 73. It is clear that the buffer 727 plays a role for exchanging data between the portable device 71 and the target destination device, such as the second storage device 723 or the USB storage device 73. However, not all the data should be transmitted to the buffer 727. In one embodiment, only the command, request or instructions exchanged between the portable device 71 and the dock 72 have to be transmitted via the buffer 727, and other data is directly transmitted between the dock 72 and the portable device 71.

The first storage device 715 may be a SD card or other kinds of memory cards. The first storage device 712 is inserted and mounted to the portable device 71 by user and stores user's personal data. The portable device 71 may comprises another storage device storing the necessary data for the operation of the portable device 71, such as the operating system, application programs or hardware configuration data.

In other embodiment, when the portable device 71 connects to the dock 72, the control of the first storage device 715 is transferred to the USB OTG controller 721. In other words, the first storage device 315 can only be accessed by the USB OTG controller 721 and cannot be accessed by the first controller 711. The first application program 713 is executed by the first controller 711 and user can select at least one file to be backed up to the dock 72 via the first application program 713. After selecting files, the first application program 713 creates a first log file. The first application program 713 may show a setting menu for user to select files to be backed up.

After the first log file is created, the first log file is transmitted to and stored in the buffer 727, and the USB OTG controller 721 reads the first log file stored in the buffer 727 and then backs up files from the first storage device 715 to the second storage device 723 or the USB storage device 73. The files that need to be backed up is first transmitted to the buffer 727 and then re-transmitted to the second storage device 723.

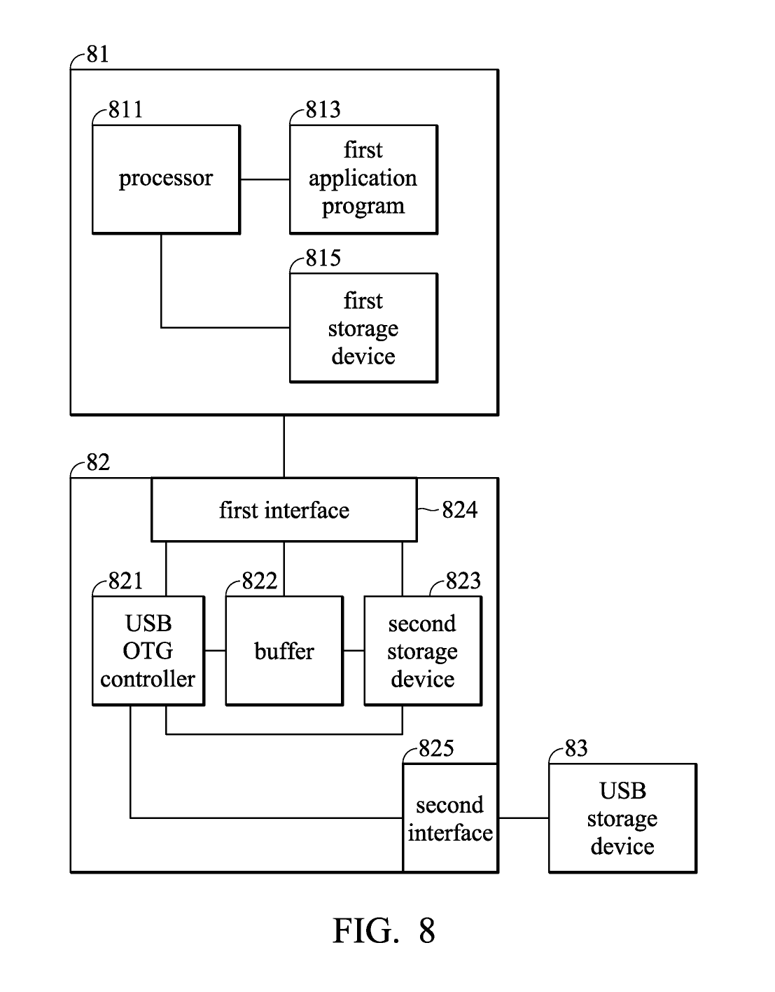

The detail backup mechanism can be referred to the description of FIG. 3 and not discussed here for briefly. In the previous paragraphs, the timestamp, the incremental backup mechanism and the structure of log file have been discussed and can be applied to this embodiment. The major technical feature of FIG. 7 is the buffer 727, and the user can determine whether the data transmitted to the dock 72 or the portable device 71 has to be transmitted via the buffer 727. In one embodiment, all the data transmitted between the dock 72 and the portable device 71 must be via the buffer 727. In other embodiment, only the command, request or instructions exchanged between the portable device 71 and the dock 72 have to be transmitted via the buffer 727. For the detail description, please refer to FIG. 8.

FIG. 8 is a schematic diagram of a backup mechanism for a portable device according to another embodiment of the invention. The portable device 81 comprises a processor 811, a first application program 813 and a first storage device 815. The first application program 813 is executed by the processor 811 and shows an option menu for a user to select files to be backed up or restored. The operation of the first application program 813 can be referred to FIG. 4 and corresponding description. The first storage device 815 is an internal storage device. The portable device 81 further comprises a slot, to which a memory card can be inserted in. The data stored in the first storage device 815 and the memory card can be backed up to the dock 82.

When a user wants to back up first files to the dock 82, the first application 813 is executed by the processor 811 to create a first log file. The first log file is then transmitted to the buffer 822 via the first interface 824. The USB OTG controller 821 then transmits the first log file from the buffer 822 to the second storage device 823. The USB OTG controller 821 reads the first log files to know which files need to be backed up and which folder the files are to be stored in. In one embodiment, the USB OTG controller 821 transmits an instruction or data to the processor 811 to informs the processor 811 that the data to be backed up should directly transmitted to the second storage device 823 or transmitted to the second storage device 823 via the buffer 822.

The user can determines the first files to be stored in the second storage device or the USB storage device 83 via the first application program 813. The information of the USB storage device 83 is provided by the USB OTG controller 821. When the portable device 81 connects to the dock 82 via a wired connection or a wireless connection, the USB OTG controller 821 first transmits status information of the second storage device 823 and the USB storage device 83.

The status information comprises an original capacity of the second storage device 823 and the USB storage device 83, the available capacity of the second storage device 823 and the USB storage device 83 and the name of the second storage device 823 and the USB storage device 83. In one embodiment, the portable device 81 comprises a first NFC (Near Field Communication) device and the dock 82 comprises a second NFC device. The status information is transmitted via the first NFC device and the second NFC device. When the portable device 81 approaches to the dock 82, the second NFC device of the dock 82 automatically transmits the status information to the first NFC device of the portable device 81. The status information is then stored in the first storage device 815 and when the first application program 813 is executed, the first application program 813 reads the status information and shows on an option menu for the user. The user can selects the first files to be backed up and selects the folder or directory that the first files are stored in. Finally, the first log file is generated according to user's selection.

When the portable device 81 transmits first files to the dock 82, the first interface 824 directs the first files to the buffer 822 or the second storage device 823 according to a select signal from the USB OTG controller 821. In the embodiment, the buffer 822 may be embedded inside the USB OTG controller 821 or the buffer 822 is accessed only by the USB OTG controller 821. The USB OTG controller 821 can assign the buffer 822 to other device, such as the portable device 81.

Since the processor 811 knows the first files will be directly transmitted to the second storage device 823 or transmitted to the second storage device 823 via the 822 according to the instruction from the USB OTG controller 821, the processor 811 adjusts the size of the first files according to the size of the buffer 822. In one embodiment, the processor 811 may compress the first files to generate a compressed file and the compressed file may be divided into a plurality of parts according to the size of the buffer 822 when the size of the compressed file is larger than the size of the buffer 822. Each part of the compressed file is transmitted to the second storage device 823, and then the USB OTG controller 821 combines the parts to generate the first files.

When the buffer 822 is full, the USB OTG controller 821 transmits the data stored in the buffer 822 to the second storage device 823. The described operations will repeat until all the first files are stored in the second storage device 823. The USB OTG controller 821 then generates a second log file indicating the backup status and the second log file is transmitted to and stored in the first storage device 815 via the selected transmission path. If the first files are directly transmitted to the second storage device 823, the second log file is directly transmitted to the first storage device 815. If the first files are transmitted to the second storage device 823 via the buffer 822, the second log file is transmitted to the first storage device 815 via the buffer 822.

The dock 82 connects to a USB storage device 83 via a second interface 825. When the first files are decided to be stored in the USB storage device 83, the first interface 824 directs the first files to the buffer 822 or the second interface 825 according to the select signal from the USB OTG controller 821. After the backup operation, the USB OTG controller 821 generates the second log file indicating the backup status and the second log file is transmitted to and stored in the first storage device 815 via the selected transmission path.

The following paragraphs discuss four relative examples according to FIG. 8. The four examples contain the same key feature that at least the log file is transmitted via the buffer 822.

### FIRST EXAMPLE

When the portable device 81 connects to the dock 82, the control of the first storage device 815 is transferred to the USB OTG controller 821. In other words, the first storage device 815 can only be accessed by the USB OTG controller 821 and cannot be accessed by the first controller 811. The first log file created by the first application program 813 is stored in the first storage device 815 and is then transmitted to the second storage device 823 via the buffer 822. The USB OTG controller 821 reads the first log file and retrieves corresponding to the first files that indicating by the first log file. The first log file is created by the first application program 813.

When the USB OTG controller 821 retrieves the first files, the first files first transmitted to the first interface 824 and the USB OTG controller 821 controls the first interface 824 to direct the first files to the buffer 822 or to the second storage device 823. When the first files are directed to the buffer 822, the USB OTG controller 821 monitors the status of the buffer 822 to transmitted the data stored in the buffer 822 to second storage device 823 when the buffer 822 is full or the remaining capacity of the buffer 822 is less than a predetermined value. In other example, the first files are directly transmitted to the second storage device 823. If the first files are backed up to the USB storage device 83, the first files are transmitted to the USB storage device 83 via the buffer 822 or a transmission path between the first interface 824 and the second interface 825 is created by the USB OTG controller 821, so that the first files can be directly transmitted to the USB storage device 83. The transmission path is created by the USB OTG controller 821.

After the backup operation, the USB OTG controller 821 creates a second log file indicating the backup status of the first files. The second log file is transmitted to the first storage device 815 via the buffer 822. When the portable device 81 disconnects from the dock 82 or the backup operation is completed, the control of the first storage device 815 is returned back to the processor 811. The processor 811 reads the second log file stored in the first storage device 815 to know the backup result.

### SECOND EXAMPLE

When the portable device 81 connects to the dock 82, the processor 811 transmits the first log file to the dock 82 and waits a response from the USB OTG controller 821. In this example, at least the first log file is transmitted to the second storage device 823 via the buffer 822. The control of the first storage device 815 is not transferred to the USB OTG controller 821. When the USB OTG controller 821 receives the first log file, the USB OTG controller 821 determines whether the first files corresponding to the first log file are stored in the second storage 823 or the USB storage device 83 via the buffer 822. In other words, the USB OTG controller 821 determines a transmission path between the first interface 824 and the second storage device 823. When the transmission path is determined, the USB OTG controller 821 transmits the response to the processor 811. When processor 811 receives the response, the processor 811 transmits the first files to the first interface 824 of the dock 82. The first interface 824 directs the first files to buffer 822 or the second storage device 823 according to the control of the USB OTG controller 821.

In other example, when the first files are backed up to the USB storage device 83, the USB OTG controller 821 establishes other transmission path between the first interface 824 and the second interface 825. When the first interface receives 824 receives the first files, the first interface 824 directs the first files to buffer 822 or the second interface 825 according to the control of the USB OTG controller 821.

In the second example, the portable device 81 and the dock 82 operates independently. In other words, the processor 811 controls the transmission of the first files between the portable device 81 and the first interface 824, and the USB OTG controller 821 controls the transmission of the first files between the first interface 824 and the second storage device 823 or the USB storage device 83.

After the backup operation, the USB OTG controller 821 creates a second log file indicating the backup status of the first files. The second log file is transmitted to the first storage device 815 via the buffer 822. When the portable device 81 disconnects from the dock 82 or the backup operation is completed, the processor 811 reads the second log file stored in the first storage device 815 to know the backup result.

### THIRD EXAMPLE

When the user of the portable device 81 wants to restore second files from the dock 82, the user selects the second files via the first application program 813 to create a third log file. The generation of the third log file can be referred to the previous paragraphs and not discussed here for briefly.

When the portable device 81 connects to the dock 82, the control of the first storage device 815 is transferred to the USB OTG controller 821. In other words, the first storage device 815 can only be accessed by the USB OTG controller 821 and cannot be accessed by the first controller 811. The third log file created by the first application program 813 is stored in the first storage device 815 and is then transmitted to the second storage device 823 via the buffer 822. The USB OTG controller 821 reads the third log file and finds corresponding to the second files that indicating by the third log file.

The USB OTG controller 821 then determines a transmission path between the second storage device 823 and the first interface 824. The second files may be directly transmitted from the second storage device 823 to the first interface 824 or transmitted from the second storage device 823 to the first interface 824 via the buffer 822. If at least one second file is stored in the USB storage device 83, the USB OTG controller 821 creates other transmission path between the first interface 824 and the second interface 825.

The USB OTG controller 821 transmits the second files via the selected transmission path to the first interface 824 and then the second files are transmitted to the first storage device 815. When the second files are transmitted via the buffer 822, the USB OTG controller 821 monitors the status of the buffer 822 to transmit the data stored in the buffer 822 to the first storage device 815 when the buffer 822 is full or the remaining capacity of the buffer 822 is less than a predetermined value.

After the restore operation, the USB OTG controller 821 creates a fourth log file indicating the restore status of the second files. The fourth log file is transmitted to the first storage device 815 via the buffer 822. When the portable device 81 disconnects from the dock 82 or the restore operation is completed, the control of the first storage device 815 is returned back to the processor 811. The processor 811 reads the fourth log file stored in the first storage device 815 to know the restore result.

### FOURTH EXAMPLE

When the portable device 81 connects to the dock 82, the processor 811 transmits the third log file to the dock 82 and waits a response from the USB OTG controller 821. The third log file is generated by the first application program and transmitted to the second storage device 823 via the buffer 822. Noted that in this example, at least the third log file is transmitted to the second storage device 823 via the buffer 822. In this example, the control of the first storage device 815 is not transferred to the USB OTG controller 821.

The USB OTG controller 821 reads the third log file and finds corresponding to the second files that indicating by the third log file. The USB OTG controller 821 then determines a transmission path between the second storage device 823 and the first interface 824. The second files may be directly transmitted from the second storage device 823 to the first interface 824 or transmitted from the second storage device 823 to the first interface 824 via the buffer 822. If at least one second file is stored in the USB storage device 83, the USB OTG controller 821 creates other transmission path between the first interface 824 and the second interface 825.

The USB OTG controller 821 transmits the second files via the selected transmission path to the first interface 824 and then the second files are transmitted to the first storage device 815 via the first interface 824. When the second files are transmitted via the buffer 822, the USB OTG controller 821 monitors the status of the buffer 822 to transmit the data stored in the buffer 822 to the first storage device 815 when the buffer 822 is full or the remaining capacity of the buffer 822 is less than a predetermined value.

In the fourth example, the portable device 81 and the dock 82 operates independently. In other words, the processor 811 controls the transmission of the second files between the portable device 81 and the first interface 824, and the USB OTG controller 821 controls the transmission of the second files between the first interface 824 and the second storage device 823 or the USB storage device 83.

After the backup operation, the USB OTG controller 821 creates a fourth log file indicating the restore status of the second files. The fourth log file is transmitted to the first storage device 815 via the buffer 822. When the portable device 81 disconnects from the dock 82 or the restore operation is completed, the processor 811 reads the fourth log file stored in the first storage device 815 to know the restore result.

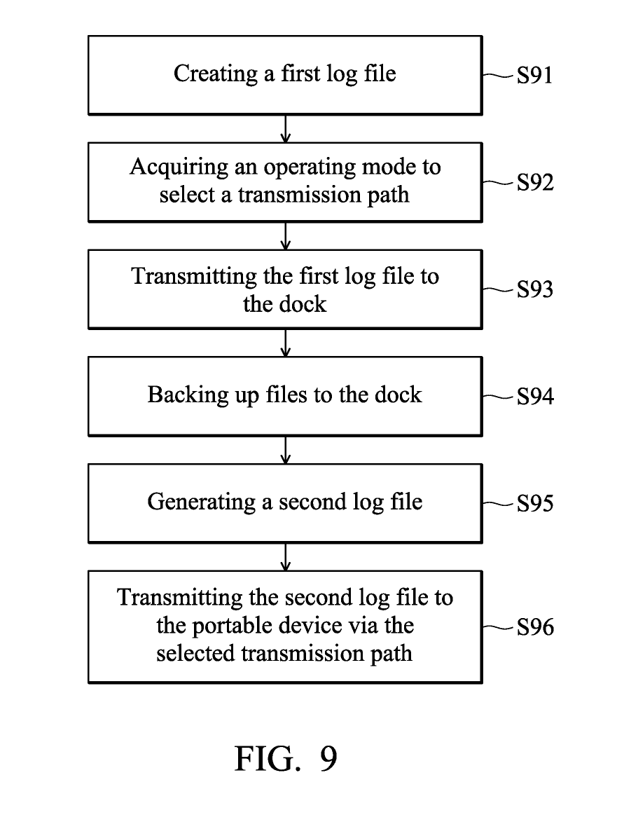

FIG. 9 a flowchart of a backup method according to another embodiment of the invention. In step S91, an application program is executed to select at least one file to be backed up in a dock to generate a first log file. The generation log file can be referred to the description of FIGS. 3, 4a, 4b and 4c. In step S92, the dock acquires an operating mode to select a transmission path. The operating mode can be determined by a controller of the dock according to the operating status of the dock. In another embodiment, the operating mode can be switched via a physical switch by a user. The operating mode determines whether the data transmitted to the dock or from the dock has to be transmitted via a buffer that is controlled by a controller of the dock.

After acquiring the operating mode, the dock selects a corresponding transmission path. In step S93, the first log file is transmitted to a second storage device of the dock via the buffer. Noted that the first log file must be transmitted to the second storage device via the buffer. In step S94, the file is transmitted from a first storage device to the second storage device for backup. After the backup operation, a second log file indicating a backup status is generated by the controller of the dock in the step S95. In the step S96, the second log file is transmitted to the portable device via the selected transmission path and a processor of the portable device reads the second log file to know the backup status.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backup method for a portable device, comprising:
creating a first log file according to a first file that has to be stored in a backup device;
connecting the portable device to the backup device;
transmitting the first log file to the backup device; and
reading the first log file, by the backup device, and storing the first file to a storage device of the backup device;
wherein the first log file is transmitted to the storage device via a buffer that is controlled by a controller of the backup device.

2. The method as claimed in claim 1, wherein the first file is transmitted to the storage device via the buffer.

3. The method as claimed in claim 1, further comprising:
when the backup device receives the first file, the controller controls the first file to be transmitted to the storage device directly or via the buffer.

4. The method as claimed in claim 1, wherein the storage device is a second storage device and when the portable device connects to the backup device, the control of a first storage device of the portable device is transferred to the backup device.

5. The method as claimed in claim 4, further comprising:
when the backup device finishes storing the first file, the control of the first storage device is returned to the portable device from the backup device.

6. The method as claimed in claim 1, further comprising:
when the backup device finishes storing the first file, the backup device generates and stores a second log file in the portable.

7. The method as claimed in claim 6, further comprising:
reading the second log file by the portable device to acquire backup status of the first file.

8. The method as claimed in claim 1, wherein the first log file comprises a file name of the first file and a timestamp.

9. A dock for storing data of a portable device, comprising:
a first storage device;
a buffer coupled to the first storage device; and
a controller to detect whether the portable device connects to the dock, and when the portable device connects to the dock, a first log file is transmitted to the first storage device via the buffer, the controller reads the first log file to store a first file from the portable device, and the controller creates a second log file indicating a backup status of the first file.

10. The dock as claimed in claim 9, wherein the first file is transmitted to the first storage device via the buffer.

11. The dock as claimed in claim 9, further comprising a first interface to direct the first file to the buffer or the first storage device according to a control signal from the controller when the first interface receives the first file.

12. The dock as claimed in claim 9, wherein when the controller receives the first log file, the controller establish a transmission path between the first storage device and a first interface that coupled to the portable device.

13. The dock as claimed in claim 9, wherein when the controller receives the first file, the controller establish a transmission path between the first storage device and a first interface that coupled to the portable device, and the first file is transmitted to the first storage device via the transmission path.

14. The dock as claimed in claim 9, further comprising a second interface to connect an external storage device, and the controller stored a second file from the portable device to the external storage device according to the first log file.
